(19) United States
(12) Patent Application Publication
(10) Pub. No.: US 2025/0124700 A1
(43) Pub. Date: Apr. 17, 2025

(54) NEURAL NETWORK ARCHITECTURE FOR IMPLEMENTING GROUP CONVOLUTIONS

(71) Applicant: Google LLC, Mountain View, CA (US)

(72) Inventors: Berkin Akin, Burlingame, CA (US); Suyog Gupta, Sunnyvale, CA (US); Cao Gao, Sunnyvale, CA (US); Ping Zhou, Santa Clara, CA (US); Gabriel Mintzer Bender, Mountain View, CA (US); Hanxiao Liu, Santa Clara, CA (US)

(21) Appl. No.: 18/694,626

(22) PCT Filed: Oct. 8, 2021
(86) PCT No.: PCT/US2021/054160

§ 371 Date: Mar. 22, 2024

(51) Int. Cl. G06V 10/82; G06V 10/77; G06V 10/94

(52) U.S. Cl. CPC G06V 10/82; G06V 10/7715; G06V 10/95

(57) ABSTRACT

Methods, systems, and apparatus, including computer-readable media, are described for processing an input image using a convolutional neural network (CNN). The CNN includes a sequence of layer blocks. Each of a first subset of the layer blocks in the sequence is configured to perform operations that include: i) receiving an input feature map for the layer block, ii) generating an expanded feature map from the input feature map using a group convolution, and iii) generating a reduced feature map from the expanded feature map. The input feature map is an h w feature map with c1 channels. The expanded feature map is an h w feature map with c2 channels, whereas the reduced feature map is an h w feature map with c1 channels. C2 is greater than c1. An output feature map is generated for the layer block from the reduced feature map.

### BACKGROUND

This specification generally relates to using integrated hardware circuits to perform group convolutions for a convolutional neural network.

Neural networks are machine-learning models that employ one or more layers of nodes to generate an output, e.g., a classification, for a received input. Some neural networks include one or more hidden layers in addition to an output layer. Some neural networks can be convolutional neural networks configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

### SUMMARY

This specification describes techniques for efficiently implementing group convolutions on a hardware neural network accelerator. Group convolutions convolve their input feature maps by grouping them along a channel dimension of an input matrix where each input group representing a group convolution is associated with a corresponding output group. In particular, based on these techniques group convolutions can be leveraged to realize certain hardware and computing efficiencies when processing an input image using a convolutional neural network (CNN) of a machine-learning model implemented on an example computing device such as a tablet or smartphone.

For example, an input image is obtained for processing using the CNN. The CNN includes a sequence of layer blocks, and each of a first subset of the layer blocks in the sequence is configured to perform operations that include: i) receiving an input feature map for the layer block, ii) generating an expanded feature map from the input feature map using a group convolution, and iii) generating a reduced feature map from the expanded feature map. The input feature map for the layer block is an h×w feature map with c1 channels. The expanded feature map is an h×w feature map with c2 channels, whereas the reduced feature map is an h×w feature map with c1 channels. C2 is greater than c1. An output feature map is generated for the layer block from the reduced feature map.

One aspect of the subject matter described in this specification can be embodied in a method performed by one or more computers. The method includes obtaining an input image and processing the input image using a convolutional neural network. The convolutional neural network includes a sequence of layer blocks. Each of a first subset of the layer blocks in the sequence is configured to perform operations that include: receiving an input feature map for the layer block, the input feature map for the layer block being an h×w feature map with c1 channels: generating an expanded feature map from the input feature map using a group convolution, the expanded feature map being an h×w feature map with c2 channels, where c2 is greater than c1: generating a reduced feature map from the expanded feature map, the reduced feature map being an h×w feature map with c1 channels; and generating an output feature map for the layer block from the reduced feature map.

These and other implementations can each optionally include one or more of the following features. For example, in some implementations, generating an expanded feature map includes: generating an initial expanded feature map from the input feature map by applying a 1×1 convolution to the input feature map, the initial expanded feature map being an h×w feature map with c2 channels; and generating the expanded feature map from the initial expanded feature map by applying the group convolution to the initial expanded feature map.

In some implementations, the 1×1 convolution has a larger number of output filters than input filters. The group convolution can have the same total number of input filters and output filters. The sequence of layer blocks can include: a group convolution layer block that is interleaved with a non-group convolution layer block, and wherein the group convolution layer block is used to implement the group convolution. In some implementations, the group convolution is a fused-group convolution implemented using a fused-grouped inverted bottleneck (IBN) layer that is included among the sequence of layer blocks.

Generating an expanded feature map can include: generating the expanded feature map from the input feature map by applying the group convolution to the input feature map. In some implementations, generating an expanded feature map includes: generating an initial expanded feature map from the input feature map by applying a 1×1 convolution to the input feature map, the initial expanded feature map being an h×w feature map with c3 channels, wherein c3 is greater than c2; and generating the expanded feature map from the initial expanded feature map by applying the group convolution to the initial expanded feature map.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. The group convolution techniques described in this document provide a novel convolutional architecture having different combinations of group convolution based neural blocks. Relative to existing uses of group convolutions, the group convolution neural blocks can be interleaved with other block types to provide a more fine grained control over the utilization metrics and computational efficiency of hardware resources of an example ML hardware accelerator.

The group convolution neural blocks of the architecture are variations of inverted-bottleneck style neural blocks and are implemented using special-purpose processors of different devices, such as mobile computing devices or edge computing platforms. The architecture incorporates different group convolution configurations, including fused or grouped variants of a baseline inverted-bottleneck (“IBN”) layer, to implement group convolutions along channel dimensions of input feature maps corresponding to an input image. The group convolution techniques can provide a neural architecture with group convolution layer blocks that are interleaved with non-group convolution layer blocks.

The interleaving of non-group convolution and group convolution based neural blocks provides an improved neural architecture for processing an input image more efficiently, such as when performing a computer vision task that involves computations for a convolutional neural network. For example, relative to a K×K depthwise convolution (i.e., non-group convolution), a neural block that implements a K×K group convolution can achieve more efficient hardware mappings of computations. The mappings are specific to a given a hardware layout of an arithmetic circuit in a special-purpose processor that implements the convolution neural network. This allows for arranging computations for group convolution layers in a manner that is optimized for hardware utilization, processing latency, or operand (e.g., inputs and weights) capacity of the integrated circuit.

The architecture can use different types of group convolution based neural blocks to apply a group convolution to different groupings of inputs along a channel dimension of an input tensor. For example, rather than a 1-to-1 relationship in terms of input to output channels, a system executes group convolutions by leveraging a block concept to perform convolutions using the different groupings of inputs along an input channel within the groups. This provides algorithmic benefits that allow for use of more information along the input channels, which can improve the representation capacity at one or more layers of a computer vision network.

The group convolution techniques can include automated (or manual) evaluation of different configurations of group convolution neural network blocks to realize various types of neural architectures for different computer vision tasks. An example system that executes these techniques can determine a neural architecture that optimizes a model's performance for constraints such as latency, parameter size, number of compute operations, and model accuracy. The model's performance can be also optimized for a given hardware integrated circuit layout of a machine-learning accelerator that is used to run the model.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system for performing group convolutions on an image.

FIG. 2 is a block diagram showing example groupings used for group convolutions.

FIG. 3 shows example attributes of a machine-learning model with regard to different convolution operations.

FIG. 4 is a block diagram showing operations corresponding to different layer blocks of a convolutional neural network.

FIG. 5 is an example architecture for a convolutional neural network model that can be used in the example computing system of FIG. 1.

FIG. 6 illustrates example loop nests for computations for a full convolution and group convolution.

FIG. 7 is a flow diagram of an example method used to process an image using group convolutions.

Like reference numbers and designations in the various drawings indicate like elements.

### DETAILED DESCRIPTION

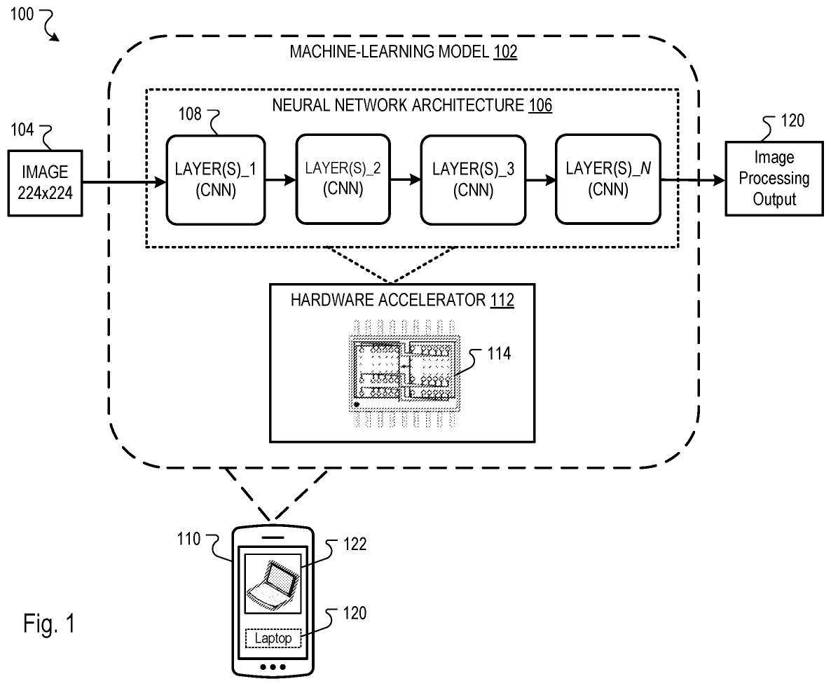

FIG. 1 is a block diagram of an example computing system 100 for performing group convolutions on an input image. The system 100 generally includes an example convolutional neural network 102 that is configured to process an image 104, i.e., to process the intensity values of the pixels of the image. The convolutional neural network 102 includes an example neural network architecture that is based on multiple convolutional neural network layers 108. In the example of FIG. 1, the convolutional neural network 102 includes multiple convolutional neural network layers 108. For example, the convolutional neural network 102 includes N number (or sets) of layers, where Nis an integer greater than ne.

Different types of CNN architectures 106 can be used to perform a variety of machine-learning tasks. For example, the machine learning task can be a computer vision task (also referred to as an “image processing task”). In other words, the neural network can be configured to receive an input image and to process the input image to generate a network output for the input image, i.e., to perform some kind of image processing task. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category.

As another example, the task can be image embedding generation and the output generated by the neural network can be a numeric embedding of the input image. As yet another example, the task can be object detection and the output generated by the neural network can identify locations in the input image, e.g., bounding boxes or other geometric regions within the image, at which particular types of objects are depicted. As yet another example, the task can be image segmentation and the output generated by the neural network can define, for each pixel of the input image, which of multiple categories the pixel belongs to. More generally, however, the task can be any of a variety of tasks, including tasks that process inputs other than images.

Some image processing tasks may be related to object detection, data classification, pattern recognition, or image recognition, as well as computational predictions that involve data modeling, and information clustering. For example, a task can involve object detection, where the CNN processes an image to detect a particular object and generates an output identifying the object upon detection of the object. Another task can involve data/image classification, where the CNN processes an image to determine a classification for the image and generates a particular classification output for the image based on the content of the image. Another task can involve pattern recognition, where the CNN processes an image to identify or recognize a particular pattern in the image and generates an output indicating the recognized pattern based on the content of the image. Another task can involve general image recognition, where the CNN processes an image to identify or recognize various elements of the image and generates an output indicating the recognized elements based on content of the image.

In some implementations, the convolutional neural network 102 is implemented at, or accessible by, an example mobile device 110. The mobile device 110 can be a smartphone, tablet, e-notebook, laptop, gaming console, or related portable computing device. In some other implementations, the convolutional neural network 102 is integrated in, or accessible by, an example cloud-based system, such as a server bank, groups of servers, or a multi-processor system.

The convolutional neural network 102 can be implemented using one or more machine-learning hardware accelerators 112. Each hardware accelerator 112 corresponds to one or more special-purpose hardware integrated circuits 114. In general, circuit 114 is a hardware circuit (e.g., special-purpose hardware circuit) that performs neural network computations. For example, some (or all) of the circuits 114 may be special-purpose hardware circuits, such as an application-specific integrated circuit (ASIC), field-programmable gate array (FPGA), a single-core neural network processor, or a multi-core neural network processor. The circuits 114 may also be a special-purpose graphics processing unit (GPU).

The hardware circuit 114 is operable to accelerate computations for a neural network workload. In some implementations, the hardware circuit 114 includes control logic, which may be implemented in hardware, software, or both. The control logic is used to issue instructions for a neural network computation, including obtaining and routing data used for the computations. The circuit 114 can include memory for storing inputs, input activations, outputs, output activations, and parameters for each of the layers of the neural network. In some implementations, the circuit 114 includes dedicated memory, shared memory, or both. For example, the circuit 114 can include an input/activation memory for storing the inputs, input activations, outputs, or output activations, and a parameter memory for storing a respective set of parameters for each of the neural network layers.

The circuit 114 can include a computation unit, such as a hardware matrix unit, an arrangement of compute tiles, or a combination of these. The computation unit is used to perform the neural network computations for processing an input through a layer of the neural network. In some implementations, each of the matrix unit or individual compute tiles include one or more arrays of compute cells, such as multiply accumulate cells that perform multiplication and accumulation operations. For example, each cell can perform a multiplication of an input and a weight value to generate a product, and perform an accumulation (e.g., addition operations) of products over multiple clock cycles.

The circuit 114 implements full, depthwise, and group convolutions to convolve different filters of weights against corresponding portions of the input matrix for a given depth of a channel dimension of the input matrix. For example, the mobile device 110 uses the convolutional neural network 102, and the model's CNN layers 108, to generate an image processing output 120, e.g., a recognition or detection output, for a received input 104. For example, the input 104 may be an image of a laptop 122 and the mobile device 110 uses the convolutional neural network 102 to process the image and detect or recognize that the image includes a depiction of a laptop.

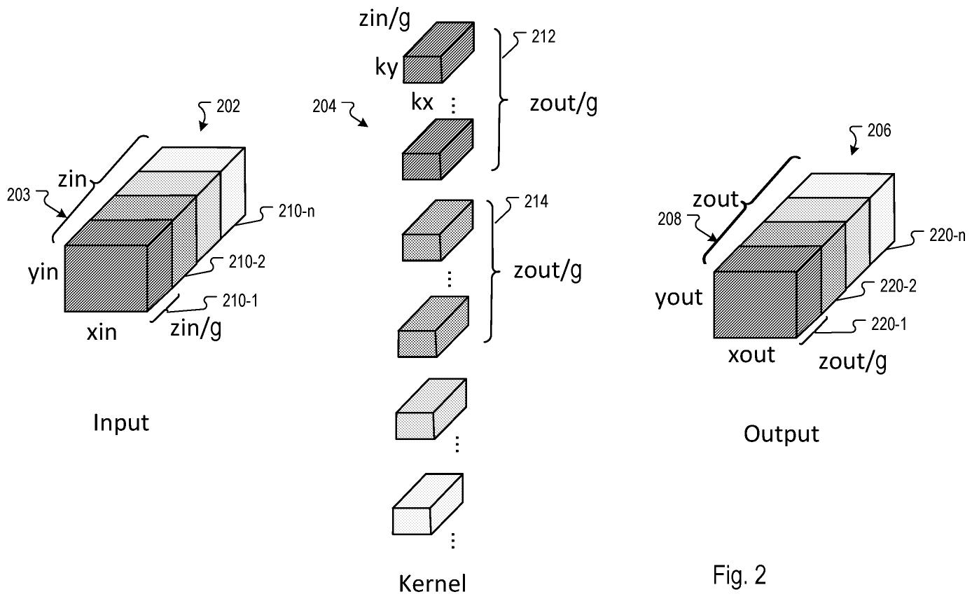

FIG. 2 is a block diagram that includes a representation of an input dataset 202 and example groupings 203 for performing group convolutions using inputs from the input dataset. In some implementations, the input dataset 202 is, or is derived from, a multi-dimensional matrix structure of inputs. For example, the matrix structure can be input tensor that includes Zin channels, each of which have spatial dimensions X by Y. The matrix structure (or tensor) can represent either a set of inputs, a set of activation inputs, or a set of weight inputs. In some cases, a matrix structure for a set of activation inputs is referred to in this specification as an input feature map, and a matrix structure for a set of weight inputs is referred to as a kernel matrix structure.

In the example of FIG. 2, the input dataset 202 is a matrix structure (or tensor) that has three dimensions: two (X,Y) spatial dimensions and one (Z) channel dimension. Regarding the spatial dimensions, in some implementations, these dimensions correspond to a space or position of a set of activation inputs. For example, if the convolutional neural network 102 is processing an image 104, which has two dimensions, the matrix structures can have two spatial dimensions, which correspond to spatial coordinates, i.e., X,Y coordinates, of the image. Regarding the channel dimension, this dimension corresponds to features from an input (e.g., an activation input). The channel dimension is described with reference to the Z. Zin, or channel dimension, where “channel” can correspond to a color channel of an image.

The system 100 is configured to determine a partitioning of group convolutions, for example, with reference to a depth level of the channel dimension of input dataset 202. Each input channel can have corresponding depth levels. For example, the matrix structure of FIG. 2 has depth levels that extend along the Zin dimension. By way of illustration, if an example matrix structure 202 represents a 3×3×3 image sent as a set of activation inputs to a convolutional neural network layer, the X and Y dimensions of the image (3×3) can be the spatial dimensions, and the Z dimension (3) can be the channel dimension corresponding to R, G, and B values.

As noted above, the system 100 can determine a partitioning of group convolutions along the channel dimension of an example input feature map. For example, the system 100 can determine a first partitioning for input group 210-1 along the channel dimension and a second partitioning for input group 210-2 along the channel dimension. In some implementations, the system 100 determines n number of groupings 210-n along the channel dimension, where n is an integer greater than or equal to 1. In the example where the input feature map 202 represents a 3×3×3 image sent as a set of activation inputs, the first partitioning to define input group 210-1 for a group convolution can correspond to a feature of nine ‘1’ activation inputs, e.g., red values, the second partitioning to define input group 210-2 for a group convolution can correspond to a feature of nine ‘2’ activation inputs, e.g., green values, and a third partitioning to define input group 210-3 for a group convolution can correspond to a feature of nine ‘3’ activation inputs, e.g., blue values.

As discussed above, group convolutions convolve their input feature maps by grouping them along a channel dimension of an input matrix, where each input group 210-n representing a group convolution is associated with a corresponding output group 220-n. The convolutional neural network 102 employs one or more convolutional neural network layers 108 to generate an output 206, e.g., a classification, for a received input 202. For example, each convolutional neural network layer has an associated set of kernels 204. The kernels 204 may be partitioned in accordance with the configuration of group convolutions, such that each input group 210-n is convolved with a corresponding kernel/weight matrix to generate a convolved output 220-n. In the example of FIG. 2, input group 210-1 is convolved with corresponding kernel matrix 212 to generate convolved output 220-1, whereas input group 210-2 is convolved with corresponding kernel matrix 214 to generate convolved output 220-2.

The system 100 is configured to dynamically determine a value for the control parameter g, where g is an integer greater than 1. The system 100 is also configured to determine a group size by computing Zin/g, where Zin is the number of input channels along a channel dimension of an input tensor and g is the number of groups as defined by the control parameter. The control parameter g is used to define a number of group convolutions (e.g., the partitioning). In some instances, the value for g may be determined dynamically at system 100 or predefined at system 100 for a given operation. For example, the control parameter g that defines a number of group convolutions can be predefined (and/or embedded) by a compiler of system 100 or dynamically determined at runtime.

In some implementations, the system 100 defines a number of group convolutions (e.g., the partitioning) based on a particular type of machine-learning task that is requested and sets the value for the control parameter g accordingly for that task. In some other implementations, the system 100 defines a number of group convolutions (e.g., the partitioning) based on: i) a type of machine-learning task to be processed: ii) the neural architecture of the convolutional neural network: iii) the compute environment: iv) performance objectives: or v) a combination of theses. Example compute environments can include cloud-based computing environments or mobile device computing environments. The performance objectives can include speed, latency, hardware utilization, model accuracy, parameter size, or a combination of these.

The group convolutions can be described as a generalized form of a convolution. In some implementations, the system 100 initializes a control parameter g by assigning a particular value to the control parameter. The initialized or assigned value of the control parameter g can be used to control the partitioning of the group convolutions. For example, if system 100 determines a convolution operation that uses data for the entire channel dimension is required (e.g., a full convolution), then the system 100 sets the value of the control parameter as g=1 and triggers and/or executes a full convolution using the relevant data of the matrix structure 202.

Relatedly, the system 100 may determine a grouping of depthwise separable convolutions are required for a given step in a larger neural network computation. For example, if system 100 determines two or more depthwise separable convolutions that use data for a portion of the channel dimension is required, then the system 100 sets the control parameter to a desired value (e.g., g=4) and triggers and/or executes the two or more (e.g., four) depthwise separable convolutions using the relevant portions of data in the matrix structure 202. In some implementations, computations for two or more group convolutions are performed sequentially, concurrently, or a combination of these. For example, some (or all) of the respective sets of computations for each of the two or more depthwise separable convolutions may be performed sequentially or in parallel.

As noted above, the group/ed convolution techniques described in this document provide a more fine grained control over at least the utilization metrics and computational efficiency of hardware resources of an example ML accelerator. In some implementations, these group convolution techniques provide versatile blocks or control knobs that are used to influence and control certain attributes or performance metrics of an example machine-learning model. For example, selection of a value of the control parameter g that is between 1 and the number of channels (z) provides a continuum between the two example constraints of a full convolution and a depthwise separable convolution. This is explained in more detail below.

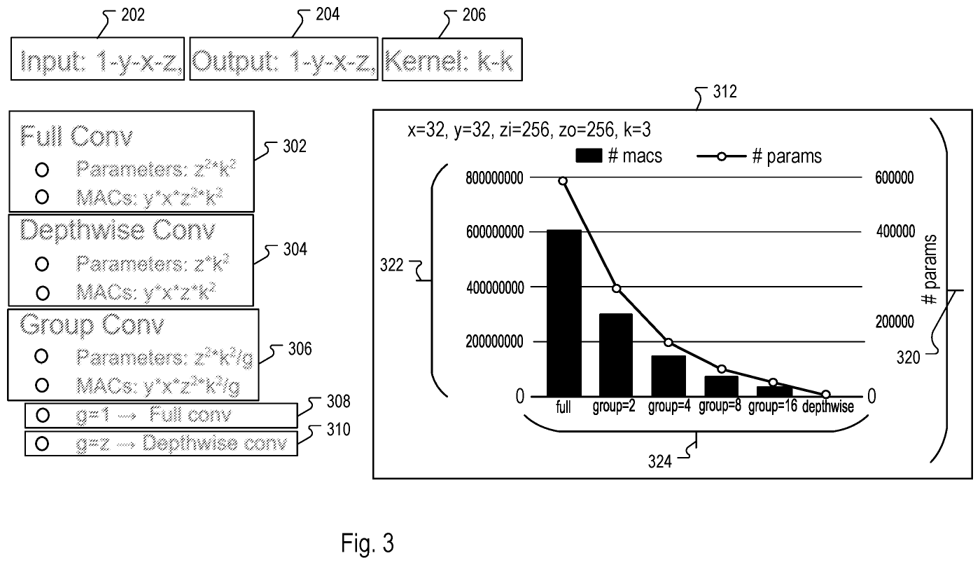

FIG. 3 shows example attributes of a machine-learning model. In general, the attributes correspond to different convolution operations performed using the convolutional neural network 102 described above. For example, attributes 302 show parameter quantities and multiply accumulate cells (MACs) that are used to perform operations for a full convolution, attributes 304 show parameter quantities and multiply accumulate cells that are used to perform operations for a depthwise convolution, and attributes 306 show parameter quantities and multiply accumulate cells that are used to perform operations for a group convolution.

The control parameter g and configuration of group convolutions can be determined and/or tuned to control a number of parameters (e.g., trainable parameters) used for a given task as well as a quantity of multiply accumulate cells used to perform operations for the task. Each of these example attributes 302, 304, 306 of the machine-learning model can have a corresponding affect or influence on different performance metrics of the model. For example, an increase or decrease in the quantity of trainable parameters, and/or the quantity of multiply accumulate cells (or operations), will have a corresponding effect on the accuracy, speed, and/or latency of the machine-learning model. In another example, relative to full convolution, use of depthwise convolutions can be a light-weight and low-cost (i.e., less resource intensive) option, but executing depthwise convolutions at integrated circuits of an ML accelerator often results in poor utilization of hardware resources of the circuit.

For example, when performing a depthwise (or depthwise separable) convolution, a standard hardware array of circuit 114 that includes tens or hundreds of hardware multiply accumulate cells can experience 3% utilization of those hardware cells for a given compute cycle, while experiencing minimal or low latency. Hence, use of depthwise convolutions may be speedy, but it is also inefficient due to its low hardware utilization. Conversely, when performing a full convolution the hardware array of circuit 114 can experience substantially higher utilization (e.g., 73%), such that a majority of the array's multiply accumulate cells are used for a given compute cycle. When compared to depthwise convolution, this higher utilization when performing full convolutions often comes at the expense of substantially higher compute latency.

As described above, the group convolution techniques described in this document provide a more fine grained control over the utilization metrics and computational efficiency of hardware resources of an example ML hardware accelerator. The selection of a value of the control parameter g that is between 1 and the number of channels (z) provides a continuum between the two example constraints of a full convolution (308) and a depthwise separable convolution (310). The system 100 can determine a partitioning of group convolutions with reference to a depth level of the channel dimension, as shown in the example of FIG. 2. The control parameter g is used to define a number of group convolutions (e.g., the partitioning).

The example graph 312 of FIG. 3 shows example parameter quantities 320 and MACs quantities 322 for a selection of different values (324) for g that are between 2 and the number of channels (z) along the continuum between a full convolution (308) and a depthwise convolution (310). In this example the zin dimension is 256. Graph 312 shows examples of the decrease in the quantity of trainable parameters and the quantity of multiply accumulate cells (or operations) relative to a corresponding increase in the value (g) of a group convolution.

As discussed above, the circuit 114 can include memory with locations corresponding to elements of a tensor that may be traversed or accessed using control logic of the circuit to compute an output of a layer, such as a group convolution layer. Elements (e.g., inputs or activations) fetched from memory must be useful for computing multiple outputs of the layer. The number of weights (i.e., parameters) can also scale with a size of a grouping. In some implementations, a transfer of parameters from memory can become a bottleneck that increases latency of a compute. When determining a preferred neural network architecture, an example set of search data or simulations can indicate a bottleneck with respect to parameter transfer time. An architecture can then be defined that uses the disclosed group convolution concepts and group convolution based neural blocks to reduce a number of parameters and improve or accelerate compute time for a machine-learning task.

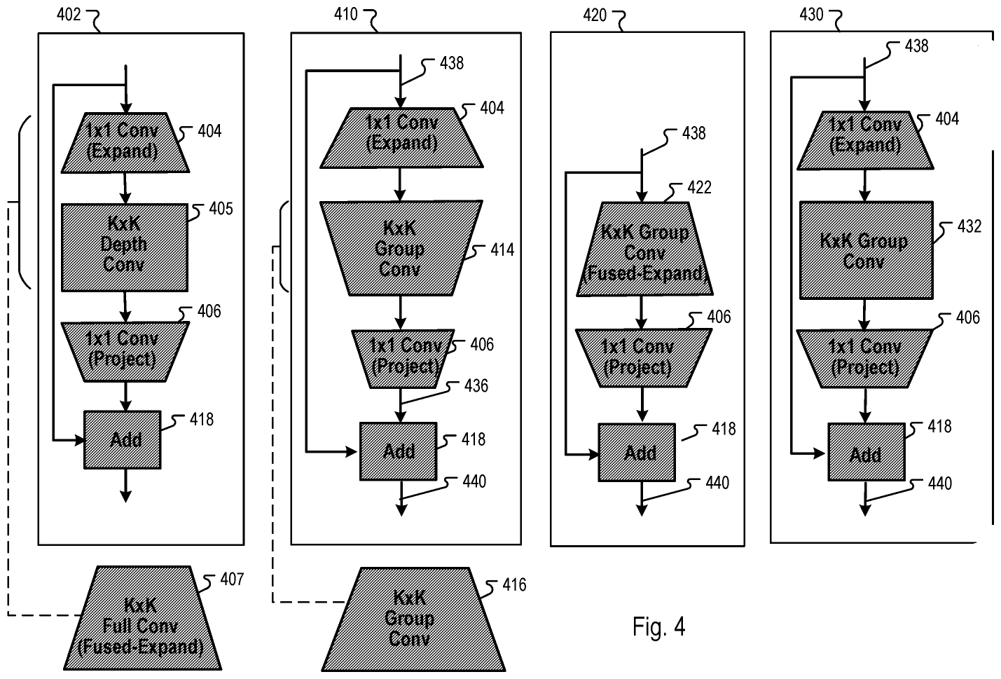

FIG. 4 is a block diagram showing examples of a process block 410, process block 420, and process block 430. Each of the process blocks 410, 420, 430 includes one or more layer blocks. In general, each of the process blocks 410, 420, 430 can be represented by different layer blocks of a convolutional neural network. In the example of FIG. 4, each of the process blocks 410, 420, and 430 can be a subset of operations that are performed for a given convolution operation. The convolution operation is executed using the convolutional neural network 102, which may be implemented on the example hardware integrated circuit 114 described above.

A neural network block can describe a single layer or a component of the neural network that includes multiple layers. A common block that is extensively used in example computer vision models, such as a mobile vision model, is an inverted bottleneck (IBN) layer block 402 (“IBN layer 402”). In general, an IBN block can be a macro block of a larger neural architecture that combines a number of convolution layers in a certain way. Multiple types of layers (or blocks), including IBN layers, are used as building blocks to form an example classification or object detection network.

An IBN layer 402 can include a pointwise convolution (404), a K×K depthwise convolution (405), and a final pointwise convolution (406). A pointwise convolution expands the channel dimension and an example of this pointwise convolution is shown at FIG. 4 as a “1×1 Conv (Expand).” The K×K depthwise convolution kernel is applied at the expanded depth of the channel dimension following the pointwise convolution. The final pointwise convolution (406) projects the expanded channel dimension back to a smaller value. An example of this final pointwise convolution is shown at FIG. 4 as a “1×1 Conv (Project).”

The use of the K×K depthwise convolutions, such as in the IBN layer block 402, is quite common. This is because, after expansion, computing full convolutions over a large or expanded channel dimension is very costly in terms of processing and computational resources. In some implementations, the pointwise convolution (404) and the K×K depthwise convolution (405) are replaced with a K×K full convolution (fused-expand) process block, which represents a fused-IBN layer 407. In general, the fused-IBN layer 407 merges expansion and depthwise convolution operations into a single full convolution neural block.

Full convolutions can involve a large number of parameters/weights and require a substantial percentage of hardware computing resources of an integrated circuit. As indicated above, examples of such resources can be multiply accumulate cells of a hardware computational array (e.g., a systolic array) of circuit 114, a vector unit of integrated circuit 114, or both. In contrast, the disclosed group convolution techniques implemented using the disclosed neural block alternatives, such as blocks 414, 416, 422, 432 described below, provide an improved approach to increasing a quantity of trainable parameters for a set of input channels (e.g., large input channels), thereby improving model accuracy, but at a lower computational cost relative to non-group convolution alternatives.

Referring now to process block 410, a grouped IBN progressive projection (or progressive expansion) block is shown where the K×K depthwise convolution (405) described above is replaced with a K×K group convolution (414) or (416). Process block 410 can have a first example that implements a K×K group convolution (414) to perform progressive projection of the channel dimension or a second example that implements a K×K group convolution (416) to perform progressive expansion of the channel dimension.

In the first example of process block 410, the system 100 can generate an expanded feature map from an input feature map (e.g., an input 438) by applying a 1×1 convolution (expand) (404) to the input feature map. The input feature map can be an h×w feature map with c1 channels. This expanded feature map can be an h×w feature map with c2 channels, where c2 is greater than c1. In some implementations, the 1×1 convolution has a larger number of output filters than input filters. The K×K group convolution (414) is applied to the expanded feature map to perform progressive projection of the channel dimension. For example, the convolutional neural network 102 can perform progressive projection on the expanded feature map using a group convolution implemented at a group convolution layer of the convolutional neural network 102. The grouped-IBN progressive projection can provide flexibility to tradeoff parameters dedicated to the projection and the main K×K convolution operators.

In this first example of process block 410, a final pointwise convolution (406) projects the expanded channel dimension back to a smaller value. Hence, a K×K kernel associated with the group convolution can perform an initial reduction in the channel size, before the 1×1 projection (406) lowers the channel size to a final value. Each of the add blocks 418 is an optional residual (or skip) connection that can be used to add an example convolved output 436 with an input 438 that is fed to a given process block (e.g., 410). The example sum 440 is passed as an output of operations performed at a corresponding process block.

In the second example of process block 410, the system 100 can generate an initial expanded feature map from an input feature map (e.g., an input 438) by applying a 1×1 convolution (expand) (404) to the input feature map. This initial expanded feature map can be an h×w feature map with c2 channels, where c2 is greater than c1. The system 100 generates an expanded feature map from the initial expanded feature map by applying a K×K group convolution (416) to the initial expanded feature map. For example, the convolutional neural network 102 can generate the expanded feature map from the initial expanded feature map using a group convolution implemented at a group convolution layer of the convolutional neural network 102. The expanded feature map can be an h×w feature map with c3 channels, where c3 is greater than c2. This grouped-IBN progressive expansion operation can provide flexibility to trade-off parameters dedicated to the expansion and the main K×K convolution operators. The grouped-IBN progressive expansion can keep part of the expansion layer un-fused and allow channel-wise convolution across groups before the main K×K convolution. A final pointwise convolution (406) of process block 410 projects the expanded channel dimension back to a smaller value.

Referring now to process block 420, this process block is a fused-grouped IBN block where the 1×1 convolution (expand) (404) and the K×K depthwise convolution (405) described above are replaced with a K×K group convolution (422). This K×K group convolution (422) includes a “fused-expand” designation at least because it allows for replacing a pointwise (404)+depthwise (405) pair and fusing aspects of those operations via the K×K group convolution (422) to expand the channel dimension. Thus, at process block 420, the system 100 can generate an expanded feature map from an example input feature map (e.g., an input 438) by applying the K×K group convolution (422) to the input feature map. The example input feature map can be an h×w feature map with c1 channels. The expanded feature map can be an h×w feature map with c2 channels, where c2 is greater than c1. A final pointwise convolution (406) of process block 420 projects the expanded channel dimension back to a smaller value. As noted above, a corresponding sum 440 is passed as an output of the particular operations performed at process block 420.

In some implementations, the fused-group convolution block 422 provides an alternative to the fused-IBN layer 407 that allows for more efficient processing along the channel dimensions. For example, these efficiencies may be realized at later stages of a computer vision model. In some cases, these later stages correspond to when the data resolution associated with convolutions along the channel dimension are quite large. The increase in processing speed afforded by the fused-group convolution may be particularly optimized when the process block 420, including its group convolution operations, is executed using a particular type of special-purpose integrated circuit. For example, the special-purpose integrated circuit may be a neural network processor that includes a broadcast input bus that broadcasts layer inputs from the memory to one or more compute cells of the circuit.

The fused-group convolution block 422 can require a slightly higher parameter count relative to the grouped IBN layer 414. On the continuum between the two constraints of a full convolution and a depthwise separable convolution, the fused-group IBN 422 is higher on the continuum. For example, the fused-grouped IBN layer 422 may be closer to a full convolution along the continuum from depthwise convolution to full continuum.

Referring now to process block 430, this process block is a grouped IBN block where the K×K depthwise convolution (405) described above is replaced with a K×K group convolution (432). As described above, the system 100 applies a 1×1 convolution (404) to an input 438 to generate an expanded feature map. The K×K group convolution (432) is applied at a group convolution layer of the convolutional neural network 102. The K×K group convolution (432) can have the same total number of input filters and output filters. Similar to other process blocks, a final pointwise convolution (406) of process block 430 projects the expanded channel dimension back to a smaller value and a corresponding sum 440 is passed as an output of the particular operations performed at process block 430.

The convolution operations executed at process block 430 can involve smaller expansion ratios relative to a baseline IBN layer. These smaller expansion ratios can lead to reduced parameter counts. To recover the parameter counts, convolution operations of process block 430 (as well as other process blocks) can use a group convolution for the K×K kernel which leverages cross-channel information. The K×K group convolution (432) can be interleaved with other block types that include a convolution along the input channel dimension. This interleaved pattern can mitigate the lack of cross-group input channel convolutions.

In general, the respective architecture of process blocks 410, 430 replaces the K×K depthwise convolution with a K×K group convolution. At least one advantage of replacing the K×K depthwise convolution with a K×K group convolution is that the K×K group convolution yields more trainable parameters with reduced latency relative to a full convolution. The additional trainable parameters from use of the K×K group convolution contributes to an increase in model accuracy. This increased accuracy can be achieved with only a slight or minimal increase in latency when compared to the depthwise convolution.

The replacement of the depthwise convolution with the group convolution can be specific to convolution operations for particular types of hardware accelerators, such as tensor processing units (TPUs) that are configured for mobile device or Edge computing applications. In some implementations, relative to the K×K depthwise convolution, a K×K group convolution may be configured to achieve more efficient hardware mappings with regard to a hardware layout of integrated circuit 114. For example, rather than a 1-to-1 relationship in terms of input to output channels, a group convolution can leverage a block concept to perform convolutions along the input channel within the groups. This provides algorithmic benefits that allow for use of more information along the input channels, which improves the representation capacity at one or more layers of a computer vision network.

Channel dimensions can get larger as computations for certain machine-learning tasks progress to deeper layers of a CNN. In an attempt to realize certain performance improvements, such as output accuracy or computing/processing speed, prior approaches explored using fused IBN layer blocks, such as the fused-IBN layer 407 described above. However, use of fused-IBN layers becomes impractical due to the cost of performing a full convolution over the larger respective dimensions of the input channels (zin), which leads to slower computing speeds.

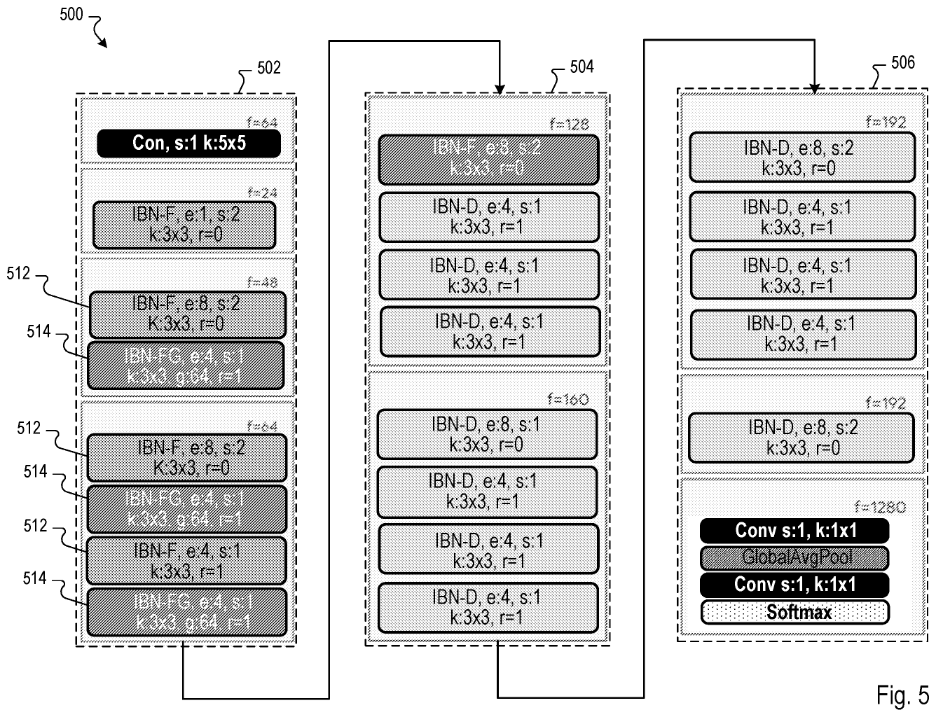

Relative to prior approaches, the respective group convolutions of process blocks 410, 420, and 430 provide neural block alternatives that can each improve model performance, while minimizing certain processing penalties. For example, the fused-grouped IBN block 422 can be used to achieve performance improvements, without the latency or expansive/large dataset processing penalties that are associated with conventional IBN layers or fused-IBN layers. In general, each of the group convolution blocks 414, 416, 422, 432 are neural network blocks that can include one or more group convolution layers. Moreover, each of the group convolution blocks 414, 416, 422, 432 can be interleaved with other layers or block types that implement a convolution along the input channel dimension. An example of interleaved neural blocks is illustrated at FIG. 5.

The interleaved pattern can mitigate the lack of cross-group input channel convolutions. For example, while group convolution uses cross-channel information, such information is limited to a group only, and a shuffle operation is typically required to mix information along the channel dimension when groups are used. The interleaved pattern also avoids the use of these additional shuffle operators (e.g., ShuffleNet). Much like blocks 410 and 430, the fused-group convolution operation, e.g., via block 422, can generate more trainable parameters relative to the baseline IBN and allows for increases in processing speed (e.g., runs faster) compared to the baseline IBN and fused IBN layers for certain types of tensor shapes.

In some implementations, depthwise convolutions limit the input and output channels to be the same size, however group convolutions can enable different sizes. For example, a K×K group convolution (414) kernel can perform an initial reduction in the channel size, before the 1×1 projection lowers the channel size to a final value. One assumption here is that if group convolutions reduce channels to a final channel dimension, thereby eliminating the 1×1 projection, the performance can be less than optimal (e.g., degraded) due to the small channel depth (20) per group. But, this can be mitigated if group convolutions are natively supported via an integrated circuit configuration that allows for implementation of progressive expansion. For example, the circuit configuration can include an input bus that allows for passing inputs to distinct MACs of the integrated circuit.

The system 100 is operable to select from multiple different types of group convolution blocks. For example, in addition to the group convolution blocks 414, 416, 422, 432 described above, the system 100 can also select from a fused-projection-grouped convolution block that implements a K×K group convolution. The fused-projection-grouped convolution fuses pointwise projection into the K×K main convolution (instead of fusing pointwise expansion). Depending on the tensor shapes, the fused-projection grouped-IBN may provide more trainable parameters while achieving similar processing efficiency compared to fused-IBN. The fused-projection grouped-IBN keeps part of the projection layer un-fused and allows channel-wise convolution across groups after the main K×K convolution.

FIG. 5 is an example architecture 500 for a convolutional neural network of a machine-learning model 102 that can be used in the example computing system of FIG. 1. The neural architecture 500 can implement multiple respective sets of convolution operations to obtain different characterizations of an example input image. In some implementations, system 100 is operable to strategically select and place various IBN layer/block options from the grouped and non-grouped IBN options described above with reference to the example of FIG. 4. In some implementations, the system 100 is operable to select and arrange the operations in a stacked, connected, or combined configuration (i.e., arrange and combine them together) to form the example architecture 500, which may be used to implement a large scale computer vision network/model.

In the example of FIG. 5, the architecture 500 includes a sequence of layer blocks, where each of a first subset of the layer blocks in the sequence is configured to perform operations for processing an input image. More specifically, the architecture 500 includes a first subset of layer blocks 502, a second subset of layer blocks 504, and a third subset of layer blocks 506. In some implementations, at least one subset of layer blocks 502, 504, 506 can include an alternating sequence of two or more different types of neural blocks. For example, the subset of layer blocks 502 can have an alternating sequence that includes a fused-IBN layer and a fused-group IBN layer.

The fused-IBN layer can represent a first individual neural block 512, such as fused-IBN layer 407 (described above) that merges expansion and depthwise convolution operations into a single full convolution neural block, whereas the fused-group IBN layer can represent a second individual neural block 514, such as fused-group IBN 422 that allows for replacing a pointwise (404)+depthwise (405) pair and fusing aspects of those operations via the K×K group convolution (422) to expand the channel dimension. As discussed above, this block can provide an alternative to the fused-IBN layer 407 that allows for more efficient processing along the channel dimensions.

More specifically, the first neural block 512 can be a non-grouped IBN block, whereas the second neural block 514 can be a grouped IBN block. Each of the first and second neural blocks 512, 514 includes one or more convolutional neural network layers. Hence, layer blocks 502 can include an alternating sequence of grouped and non-grouped IBN layers. For example, the alternating sequence of layer blocks can have group convolution layer blocks that are interleaved with non-group convolution layer blocks.

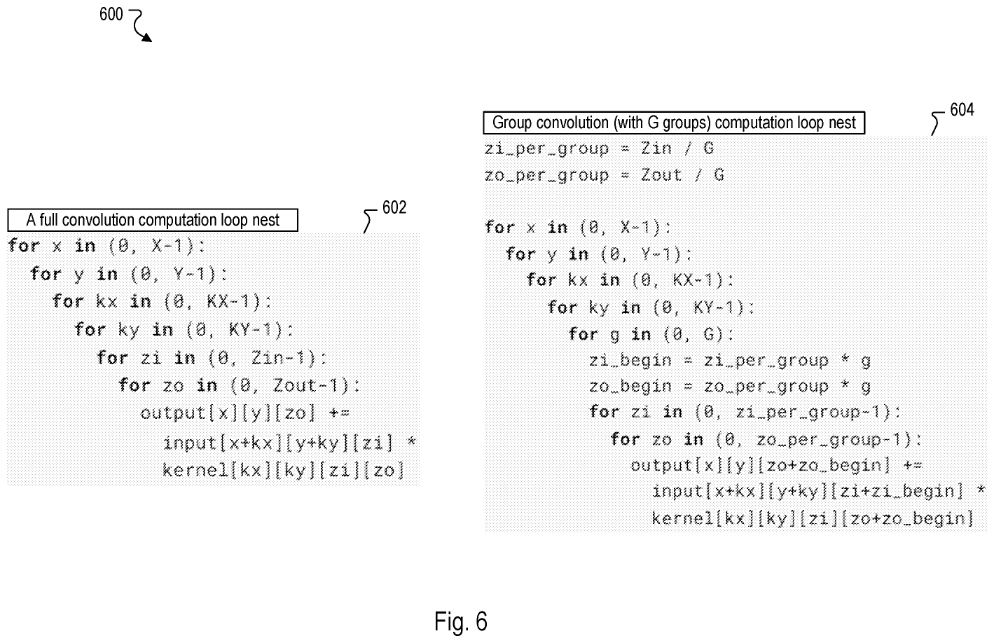

FIG. 6 illustrates example computation loop nests 600. A first computation loop nest 602 represents a loop nest for a full convolution computation, whereas a second computation loop nest 604 represents a loop nest for a group convolution computation with g groups.

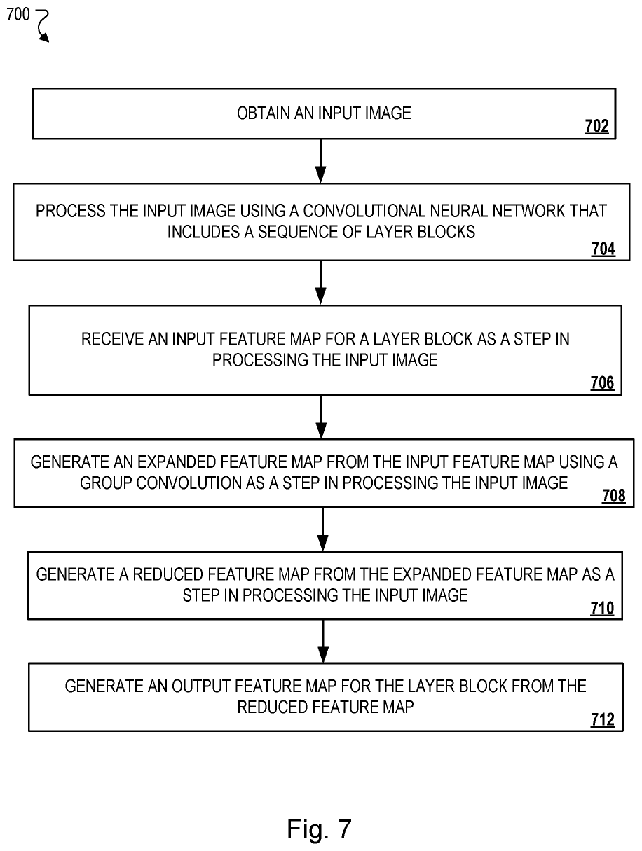

FIG. 7 is a flow diagram of an example method 700 used to process an example image using group convolutions. The example image may be image 102 described above or various other types of digital images and related graphical data. In some implementations, method 700 is part of a technique used to accelerate neural network computations that also allows for improved accuracy in terms of image processing outputs, relative to other data processing techniques.

Method 700 can be implemented or executed using the system 100 described above. Hence, descriptions of method 700 may reference the above-mentioned computing resources of system 100. The steps or actions of method 700 can be enabled by programmed firmware, or software instructions, that are executable by one or more processors of the devices and resources described in this document. In some implementations, the steps of method 700 correspond to a method for performing computations to generate an output for a neural network layer using a hardware integrated circuit, such as a special-purpose neural network processor or hardware machine-learning accelerator configured to implement the neural network.

Referring again to method 700, the system 100 obtains an input image (702) and processes the input image using an example convolutional neural network (704). The convolutional neural network includes a sequence of layer blocks that are used to implement group convolutions for processing a digital input image, such as image 102. An individual layer block may correspond to a group convolution operation executed at a hardware integrated circuit 114 that implements the convolutional neural network 108. The layer blocks in the sequence of layer blocks can also include blocks that do not correspond to a group convolution operation.

For example, a sequence of layer blocks can include, or be formed, from group convolution layer blocks and non-group convolution layer blocks. In some implementations, the sequence of layer blocks has group convolution layer blocks that are interleaved with non-group convolution layer blocks. For example, some (or all) of the individual sequences of layer blocks can have group convolution layer blocks that are interleaved between non-group convolution layer blocks. In some other implementations, individual sequences of layer blocks can have differing arrangements of group convolution layer blocks and non-group convolution layer blocks. For example, rather than being interleaved, a sequence of layer blocks can be formed from distinct subsets of sequential group convolution layer blocks and sequential non-group convolution layer blocks.

The system 100 can determine a grouping of convolutions based on one or more constraints for a computer vision task or neural network architecture. The system 100 can then determine an input group that corresponds to a group convolution based on the determined grouping. For example, the system 100 can group input feature maps of an input matrix along the channel dimension of the input matrix to form one or more input groups. The input matrix is derived from the input image. The system 100 can associate a corresponding kernel matrix with each input group and convolve the kernel matrix with the corresponding input group to generate a corresponding output group of an output matrix.

Each of a first subset of the layer blocks in the sequence of layer blocks is configured to perform various types of operations related to image processing. For example, a subset of the layer blocks of the sequence included in the CNN is configured to receive an input feature map for the layer block (706). In some implementations, the input feature map for the layer block is an h×w feature map with c1 channels. The subset of the layer blocks is configured to generate an expanded feature map from the input feature map using a group convolution (708). In some implementations, the expanded feature map is an h×w feature map with c2 channels, where c2 is greater than c1. The subset of the layer blocks is configured to generate a reduced feature map from the expanded feature map (710). In some implementations, the reduced feature map is an h×w feature map with c1 channels.

The subset of the layer blocks is configured to generate an output feature map for the layer block from the reduced feature map (712). In some implementations, the subset of the layer blocks generates an output feature map by adding the input feature map to the reduced feature map. In some other implementations, the subset of the layer blocks generates an output feature map that directly corresponds to the reduced feature map. For example, in these implementations the output feature map is equal to the reduced feature map.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few:

Computer readable media suitable for storing computer program instructions and data include all forms of nonvolatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
obtaining an input image; and
processing the input image using a convolutional neural network, the convolutional neural network comprising a sequence of layer blocks, and wherein each of a first subset of the layer blocks in the sequence is configured to perform operations comprising:
receiving an input feature map for the layer block, the input feature map for the layer block being an h×w feature map with c1 channels;
generating an expanded feature map from the input feature map using a group convolution, the expanded feature map being an h×w feature map with c2 channels, where c2 is greater than c1;
generating a reduced feature map from the expanded feature map, the reduced feature map being an h×w feature map with c1 channels; and
generating an output feature map for the layer block from the reduced feature map.

2. The method of claim 1, wherein generating an expanded feature map comprises:
generating an initial expanded feature map from the input feature map by applying a 1×1 convolution to the input feature map, the initial expanded feature map being an h×w feature map with c2 channels; and
generating the expanded feature map from the initial expanded feature map by applying the group convolution to the initial expanded feature map.

3. The method of claim 2, wherein the 1×1 convolution has a larger number of output filters than input filters.

4. The method of claim 2, wherein the group convolution has the same total number of input filters and output filters.

5. The method of claim 1, wherein the sequence of layer blocks comprises:
a group convolution layer block that is interleaved with a non-group convolution layer block, and wherein the group convolution layer block is used to implement the group convolution.

6. The method of claim 1, wherein:
the group convolution is a fused-group convolution implemented using a fused-grouped inverted bottleneck (IBN) layer that is included among the sequence of layer blocks.

7. The method of claim 1, wherein generating an expanded feature map comprises:
generating the expanded feature map from the input feature map by applying the group convolution to the input feature map.

8. The method of claim 1, wherein generating an expanded feature map comprises:
generating an initial expanded feature map from the input feature map by applying a 1×1 convolution to the input feature map, the initial expanded feature map being an h×w feature map with c3 channels, wherein c3 is greater than c2; and
generating the expanded feature map from the initial expanded feature map by applying the group convolution to the initial expanded feature map.

9. A system comprising a processing device and a non-transitory machine-readable storage device storing instructions that are executable by the processing device to cause performance of operations comprising:
obtaining an input image; and
processing the input image using a convolutional neural network, the convolutional neural network comprising a sequence of layer blocks, and wherein each of a first subset of the layer blocks in the sequence is configured to perform operations comprising:
receiving an input feature map for the layer block, the input feature map for the layer block being an h×w feature map with c1 channels;
generating an expanded feature map from the input feature map using a group convolution, the expanded feature map being an h×w feature map with c2 channels, where c2 is greater than c1;
generating a reduced feature map from the expanded feature map, the reduced feature map being an h×w feature map with c1 channels; and
generating an output feature map for the layer block from the reduced feature map.

10. The system of claim 9, wherein generating an expanded feature map comprises:
generating an initial expanded feature map from the input feature map by applying a 1×1 convolution to the input feature map, the initial expanded feature map being an h×w feature map with c2 channels; and
generating the expanded feature map from the initial expanded feature map by applying a group convolution to the initial expanded feature map.

11. The system of claim 10, wherein the 1×1 convolution has a larger number of output filters than input filters.

12. The system of claim 10, wherein the group convolution has the same total number of input filters and output filters.

13. The system of claim 9, wherein the sequence of layer blocks comprises:
a group convolution layer block that is interleaved with a non-group convolution layer block, and wherein the group convolution layer block is used to implement the group convolution.

14. The system of claim 9, wherein:
the group convolution is a fused-group convolution implemented using a fused-grouped inverted bottleneck (IBN) layer that is included among the sequence of layer blocks.

15. The system of claim 9, wherein generating an expanded feature map comprises:
generating the expanded feature map from the input feature map by applying a group convolution to the input feature map.

16. The system of claim 9, wherein generating an expanded feature map comprises:
generating an initial expanded feature map from the input feature map by applying a 1×1 convolution to the input feature map, the initial expanded feature map being an h×w feature map with c3 channels, wherein c3 is greater than c2; and
generating the expanded feature map from the initial expanded feature map by applying a group convolution to the initial expanded feature map.

17. A non-transitory machine-readable storage device storing instructions that are executable by a processing device to cause performance of operations comprising:
obtaining an input image; and
processing the input image using a convolutional neural network, the convolutional neural network comprises a sequence of layer blocks, and wherein each of a first subset of the layer blocks in the sequence is configured to perform operations comprising:
receiving an input feature map for the layer block, the input feature map for the layer block being an h×w feature map with c1 channels;
generating an expanded feature map from the input feature map using a group convolution, the expanded feature map being an h×w feature map with c2 channels, where c2 is greater than c1;
generating a reduced feature map from the expanded feature map, the reduced feature map being an h×w feature map with c1 channels; and
generating an output feature map for the layer block from the reduced feature map.

18. The machine-readable storage device of claim 17, wherein generating an expanded feature map comprises:
generating an initial expanded feature map from the input feature map by applying a 1×1 convolution to the input feature map, the initial expanded feature map being an h×w feature map with c2 channels; and
generating the expanded feature map from the initial expanded feature map by applying the group convolution to the initial expanded feature map.

19. The machine-readable storage device of claim 17, wherein the sequence of layer blocks comprises:
a group convolution layer block that is interleaved with a non-group convolution layer block, and wherein the group convolution layer block is used to implement the group convolution.

20. The machine-readable storage device of claim 17, wherein:
the group convolution is a fused-group convolution implemented using a fused-grouped inverted bottleneck (IBN) layer that is included among the sequence of layer blocks; and
generating an expanded feature map comprises: generating the expanded feature map from the input feature map by applying the group convolution to the input feature map.
